(19) United States
(12) Patent Application Publication
(10) Pub. No.: US 2016/0330225 A1
(43) Pub. Date: Nov. 10, 2016

(54) Systems, Methods, and Devices for Detecting Anomalies in an Industrial Control System

(71) Applicant: BRIGHTSOURCE INDUSTRIES (ISRAEL) LTD., Jerusalem (IL)

(72) Inventors: Gil KROYZER, Jerusalem (IL); Eyal ROSENMAN, Motsa Illit (IL)

(73) Assignee: Brightsource Industries (Israel) Ltd., Jerusalem (IL)

(21) Appl. No.: 15/111,040

(22) PCT Filed: Jan. 12, 2015
(86) PCT No.: PCT/IB15/50231

§ 371 Date: Jul. 12, 2016

Related U.S. Application Data
(60) Provisional application No. 61/926,500, filed on Jan. 13, 2014.
(60) Provisional application No. 61/926,515, filed on Jan. 13, 2014.

(51) Int. Cl. H04L 29/06; G06N 99/00; G05B 19/418

(52) U.S. Cl. CPC H04L 63/1425; G05B 19/4184; G06N 99/005; G05B 2219/31434; G05B 2219/45103; G05B 2219/31358

(57) ABSTRACT

A method of detecting anomalies in an industrial control system includes analyzing data of correct operational parameters from at least one input device and storing the correct operational parameter or a correlation of at least two operational parameters as training data. The training data is used to train an anomaly detection system. Current operational parameters of the at least one input device are detected. The anomaly detection system then checks at least one of the detected operational parameter or a correlation of at least two detected operational parameters to detect a deviation from the training data. When the detected deviation is above or below a defined threshold, a communication function is performed. For example, the communication function is at least one of creating an alarm, communicating data to at least one of a control system and an operator, and recording the data or the alarm.

### CROSS-REFERENCE TO RELATED APPLICATIONS

The present application claims the benefit of U.S. Provisional Application No. 61/926,515, filed Jan. 13, 2014, and U.S. Provisional Application No. 61/926,500, filed Jan. 13, 2014, both of which are hereby incorporated by reference herein in its entirety.

### FIELD

The present disclosure generally relates to enhancing security of control systems and, more particularly, to systems, methods, and devices for detecting anomalies in operating parameters of an industrial control system.

### BACKGROUND

Information-technology-based monitoring and control systems, generally also known as supervisory control and data acquisition (SCADA) systems, or distributed control systems (DCSs) are used in many technical units, such as industrial units, factories and power plants. In the past, these systems differed from conventional information technology (IT) systems in that they were operated in total isolation in physically protected areas and often used communication protocols not normally used in the IT environment. Such systems are now increasingly also connected to other networks to form a comprehensive control network to achieve greater increases in efficiency. In contrast to the IT environment, information security was of lower priority; as such automation networks were already intrinsically secure or were not connected to unsecure networks. Rather, fast response times in the region of milliseconds were a priority for communication between field devices (e.g., for protection functions for energy transportation and distribution). In industrial automation control, networks may control, for example, power plants, or more specifically solar power plants.

Increased networking gave rise to control networks that are easier to attack, because the intrinsic protection resulting from the isolation of the individual systems is absent. There are generally two methodologies with respect to securing SCADA control systems. The first is to identify issues at the perimeter of the system. This may be done using anti-virus and/or intrusion detection software. Previously, control networks were rarely monitored with respect to security. Instead, users relied on the isolation of the control network in respect of production control and a lack of knowledge of corresponding protocols and devices on the part of potential attackers, who generally come from the traditional IT environment. However, with the increasing connection of networks, the growing experience of attackers and their increasing motivation, and the potential commercial impact of disruptive attacks, this reliance is no longer tenable. Thus, there is a need for detection of intrusion or anomalies in industrial control systems.

Intrusion detection systems can operate in a signature-based manner. Such signatures have to be generated in a complex manner to detect individual attacks. When an installed intrusion detection system is configured, the patterns of relevant attacks are selected and made known to the intrusion detection system, for example, as a configuration file. As soon as new vulnerabilities become known or attacks on already known vulnerabilities are modified, new signatures are generated and the intrusion detection system configuration file is extended or updated in a corresponding manner. Other traffic analysis approaches detect scanning and flooding attacks based on major changes in traffic volume in the Transmission Control Protocol/Internet Protocol (TCP/IP) layer. The above-mentioned measures, as well as other measures such as firewalls, application gateways, demilitarized zones (DMZ), and security cells, can be used to protect the control network.

But the above noted measures are only effective against known viruses and attacks—they are ineffective against unknown viruses or attacks. Nor can they prevent an insider from manipulating the system to cause damage.

### SUMMARY

In one or more embodiments, a control system protection mechanism detects unauthorized interference with an industrial control system controlling an industrial system. The control system protection mechanism comprises a programmable anomaly detection module. The programmable anomaly detection module is connected to sensors to receive sensor data. The sensor data represents a configuration of the industrial system. The programmable anomaly detection module is also connected to control outputs of the industrial control system and to receive control output data. The control output data commands functions of the industrial system. The anomaly detection module comprises a processor and a data store with executable instructions to cause the processor to generate error commands responsively to a network model. The network model is on the data store of the anomaly detection module and distinguishes non-anomalous attribute combination in an attribute space defined by all possible values of the control output data and sensor data. The error commands includes at least one command applied to the industrial control system effective to cause the industrial control system to take a corrective or protective action when the network model indicates that a current combination of sensor data and control output data lies outside the non-anomalous combination. The industrial system has one or more production operating modes and one or more non-production operating modes. The non-production operating modes correspond to testing, maintenance, startup, or shutdown. The non-anomalous combinations include conditions during the non-production operating modes. The network model is generated by training the network model using unlabeled data obtained by operating the industrial system during production modes and receiving the attending sensor data and by controlling output data of the industrial system during non-anomalous operation or by selecting the attending sensor data and control output data corresponding to non-anomalous operation. The industrial control system is signally connected to the anomaly detection module to receive said at least one of the error commands. An alarm output device can be connected to the anomaly detection module to receive at least another of the error commands and to generate an alarm notification receivable by one or more operators responsively thereto. The alarm output device or the anomaly detection module is configured to detect a loss of connection between the alarm output device and the anomaly detection module and to generate an alarm notification upon said loss of connection.

In one or more embodiments, a control system protection mechanism detects unauthorized interference with an industrial control system controlling an industrial system. The control system protection mechanism comprises at least a programmable anomaly detection module connected to sensors to receive sensor data. The sensor data represents a configuration of the industrial system. The programmable anomaly detection module is also connected to control outputs of the industrial control system to receive control output data. The control output data commands functions of the industrial system. The anomaly detection module comprises a processor and a data store with executable instructions to cause the processor to generate error commands responsively to a network model that is on a data store of the anomaly detection module and distinguishes non-anomalous attribute combination in an attribute space defined by all possible values of the control output data and sensor data. The error commands include at least one command applied to the industrial control system effective to cause the industrial control system to take a corrective or protective action when the network model indicates that a current combination of sensor data and control output data lies outside the non-anomalous combination. The industrial system has one or more production operating modes and one or more non-production operating modes. The network model is generated by training the network model using labeled and unlabeled data obtained by operating the industrial system during production modes and receiving the attending sensor data and control output data of the industrial system during non-anomalous operation or by selecting the attending sensor data and control output data corresponding to non-anomalous operation. The industrial control system is signally connected to the anomaly detection module to receive the at least one of the error commands. An alarm output device is connected to the anomaly detection module to receive at least another of said error commands and to generate an alarm notification receivable by one or more operators responsively thereto. The alarm output device or the anomaly detection module is configured to detect a loss of connection between the alarm output device and the anomaly detection module and to generate an alarm notification upon the loss of connection.

In one or more embodiments, a method of detecting anomalies in an industrial control system includes analyzing data of correct operational parameters from at least one input device and storing the correct operational parameters or a correlation of at least two correct operational parameters as training data. The method further includes training an anomaly detection system using the training data and detecting current operational parameters of the at least one input device. The method further includes checking, by the anomaly detection system, at least one of an operational parameter or a correlation of at least two operational parameters to detect a deviation from the training data. The method also includes performing a communication function when the detected deviation is above or below a defined threshold. The communication function is one of creating an alarm, communicating data to at least one of a control system and an operator, and recording the data or the alarm.

In one or more embodiments, a method of detecting anomalies in an industrial control system includes analyzing historical data of correct operational parameters from at least one input device and storing the correct operational parameters or a correlation of at least two correct operational parameters as training data. The method further includes training an anomaly detection system using the training data and detecting current operational parameters of the at least one input device. The method also includes, by the anomaly detection system, analyzing the current operational parameters with respect to the training data so as to detect a deviation in the current operational parameters. The method further includes performing a communication function when the detected deviation is above or below a predefined threshold. The communication function comprises at least one of creating an alarm, communicating data associated with the detected deviation to at least one of the industrial control system and an operator, and recording the alarm or data associated with the detected deviation.

In one or more embodiments, anomalies can be detected in an industrial control system by analyzing data of correct operational parameters from at least one input device and storing the correct operational parameters or a correlation of at least two operational parameters as training data. Current operational parameters of the at least one input device can be detected, and at least one of an operational parameter or a correlation of at least two operational parameters can be checked to detect a deviation from the training data. A communication function can be performed when the detected deviation is above or below the defined threshold.

In one or more embodiments, a method of detecting anomalies in an industrial control system can include analyzing historical data of correct operational parameters from at least one input device and storing the correct operational parameters or a correlation of at least two operational parameters as training data. The method can further include detecting current operational parameters of the at least one input device, and analyzing the current operational parameters with respect to the training data to detect a deviation in the current operational parameters. The method can also include performing a communication function when the detected deviation is above or below a predefined threshold.

In one or more embodiments, a method of detecting anomalies in an industrial control system can be performed by an anomaly detection module. The anomaly detection module can analyze data representing current operational parameters of the industrial control system with respect to historical data representing normal operational parameters of the industrial control system. The anomaly detection module can also create an alarm responsively to when the analyzing indicates that the operating parameters deviate from normal operation.

In one or more embodiments, a method of detecting anomalies in an industrial control system can be performed by an anomaly detection system. The anomaly detection system can generate a model of normal operation of the industrial control system. The model can comprise values or a range of values for one or more operational parameters of the industrial control system. The model can be generated based on historical data representing normal operational parameters of the industrial control system. The anomaly detection system can analyze data representing current operational parameters of the industrial control system with respect to said model and create an alarm responsively to when the analyzing indicates a deviation from said model that exceeds a predetermined threshold.

In one or more embodiments, a system for detecting anomalies in an industrial control system can include a training module and a data analysis module. The training module can be configured to analyze historical data of operational parameters of the industrial control system and to determine normal operating criteria for evaluating current operational parameters of the industrial control system based on the analysis of the historical data. The data analysis module can be configured to analyze data indicative of current operational parameters of the industrial control system with respect to the normal operating criteria and to detect the presence of an anomaly based on a deviation determined responsively to the analysis of the current data.

In one or more embodiments, an industrial control system is configured to direct operation of control devices of at least one industrial process plant and to receive measurements of operational parameters from said industrial process plant. A method of detecting an anomaly in the industrial control system can include predicting the effect on one or more of said operational parameters of performing a predetermined modification of an operational state of at least one of said control devices. The method can further include performing the modification and monitoring the one or more operational parameters. The method can also include comparing results of the monitoring to at least one predicted effect, and determining, if the results of the monitoring deviate from the at least one predicted effect by more than a predetermined threshold, that the anomaly has occurred.

In one or more embodiments, a method of detecting an anomaly in an industrial process plant can include predicting a value of an operational parameter of the industrial process plant after a control device therein has been subject to a known operating state modification. The method can further include instructing the control device to have the known operating state modification and comparing a value of the operational parameter resulting from the instructing with the predicted value. The method also includes controlling the industrial control system responsively to a result of the comparing.

In one or more embodiments, a method of detecting an anomaly in an industrial process plant can include predicting a response of the industrial process plant to a perturbation produced by a control device therein. The response can be indicated by a change in an operational parameter of the industrial process plant. The method can further include comparing an actual response of the industrial process plant to the perturbation with the predicted result, and determining existence of an anomaly responsively to the comparing.

Objects and advantages of embodiments of the disclosed subject matter will become apparent from the following description when considered in conjunction with the accompanying drawings.

### BRIEF DESCRIPTION OF DRAWINGS

Embodiments will hereinafter be described with reference to the accompanying drawings, which have not necessarily been drawn to scale. Where applicable, some features may not be illustrated to assist in the illustration and description of underlying features. Throughout the figures, like reference numerals denote like elements.

FIG. 1 shows a process flow for detection of anomalies, according to one or more embodiments of the disclosed subject matter.

FIG. 2 shows a simplified schematic diagram of a system for detection of anomalies in an industrial control system, according to one or more embodiments of the disclosed subject matter.

FIG. 3 shows a simplified schematic diagram of portions of an industrial control system, according to one or more embodiments of the disclosed subject matter.

FIG. 4 is a schematic illustration of an industrial control system and associated industrial process plant, according to one or more embodiments of the disclosed subject matter.

FIG. 5 schematically illustrates a learning procedure, according to one or more embodiments of the disclosed subject matter.

FIG. 6 schematically illustrates another method for detecting an anomaly, according to one or more embodiments of the disclosed subject matter.

### DETAILED DESCRIPTION

An industrial control system can monitor and control operation of an industrial process system, which may be a physical system. For example, the industrial process system may be a power plant, such as a solar thermal power plant. Control devices within the industrial process system may be configured to regulate at least one or more conditions within the system, for example, temperature of a thermal fluid of the plant, pressure of the thermal fluid, angle of heliostats or reflectors of the plant, temperature of working fluid of a turbine of the plant, and pressure of working fluid of a turbine of the plant. For example, the industrial process plant may be a nuclear power plant, a fossil fuel power plant, a hydroelectric power plant, a manufacturing plant, a water treatment plant, a desalination plant, an oil refinery, a chemical plant, or a food/beverage production plant.

An industrial control system 130, for example, as illustrated in FIG. 3, can include one or more of the following elements:
(1) a supervisory computer system (e.g., SCADA 106), which gathers data on the process and sends commands to control the process;
(2) one or more Programmable Logic Controllers (PLCs) 136, which are essentially small computers used to control electromechanical processes (e.g., to switch something on or off, to control a valve, etc.);
(3) one or more Remote Terminal Units (RTUs) 134, which convert sensor signals to digital data and send digital data to the supervisory computer system 106; and
(4) a Human-Machine Interface (HMI) 132, which presents process data to a human operator and allows the operator to issue commands.
   These elements may communicate with each other over wired and/or wireless networks, including internet protocol (IP)-based networks over various transports. The elements may communicate over shared or disparate networks and may utilize Web protocols for communication and display of data.

One or more embodiments of the disclosed subject matter relate to systems, methods, and devices for resisting malicious code from tampering with or otherwise exploiting an industrial control system (e.g., a SCADA). Secure system elements may operate in a manner that assures the user that it has not been tampered with by malicious code of various types. At the same time, the various embodiments allow for the system to operate on existing hardware using existing firmware. Various embodiments provide a system which may have the ability to, for example, internally monitor activities of any function of the system, report on suspicious activity on the system by any function or program to a central server, and/or apply a series of protective measures that reside internally on the system when suspicious activity is detected.

For example, an attacker may take over an authorized observation or control station such as in the process control network, in the corporate control network, or in the control system network. The attacker may then manipulate the parts of the technical unit covered by the authorized observation or control station they have taken over. For example, in the case of a central tower solar thermal power system, an attacker may hijack control of one or more heliostats surrounding the tower and attempt to redirect the hijacked heliostats to disrupt power generation or damage the power system, e.g., by causing an imbalance in heat energy directed on the solar receiver or by heating more sensitive components of the system to a high temperature. Embodiments of the disclosed subject matter may help to recognize and prevent such attacks.

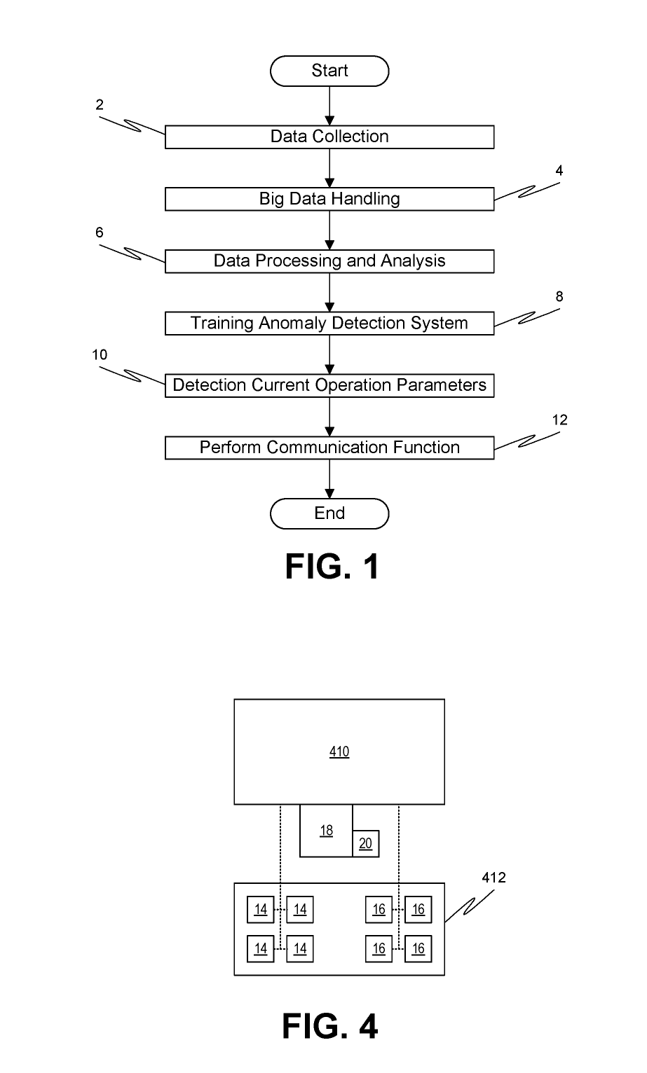

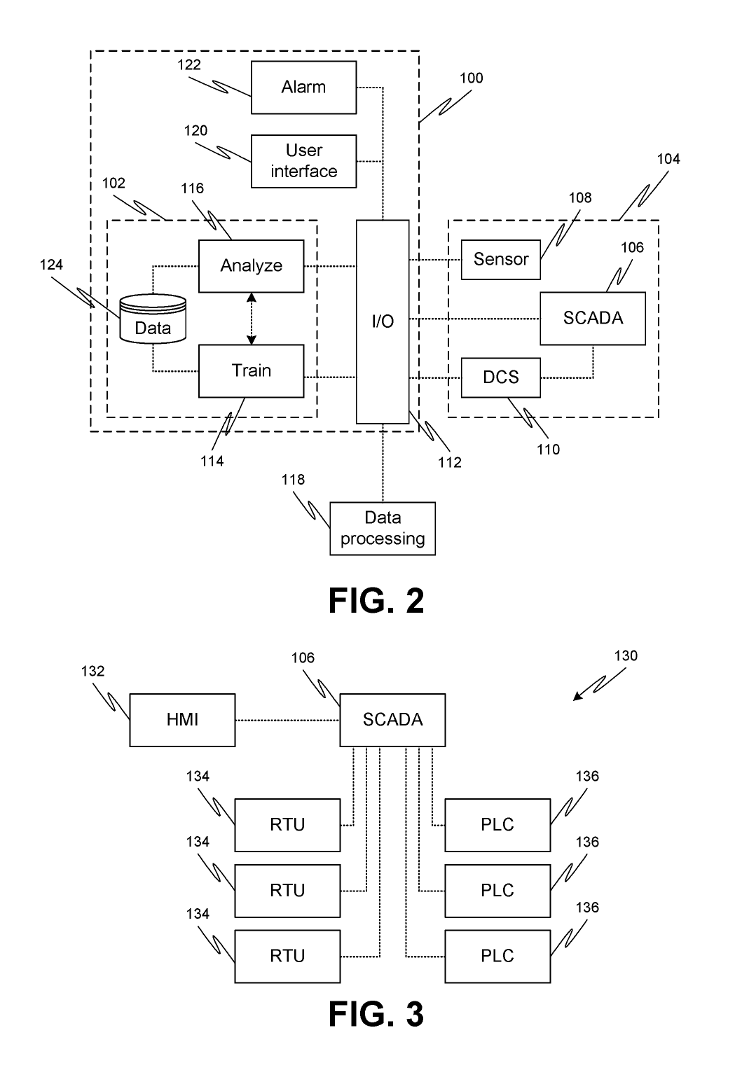

FIG. 1 illustrates an exemplary method for anomaly detection in an industrial control system, while FIG. 2 shows an exemplary system 100 for anomaly detection in the industrial control system 104.

Referring to FIG. 1, shown therein is a first step 2, a second step 4, a third step 6, a fourth step 8, a fifth step 10, and a sixth step 12 of a method in accordance with an exemplary embodiment. Although illustrated in FIG. 1 and discussed below as separate steps, it is contemplated that the one or more of the steps may be combined together or further divided into multiple substeps. Moreover, although illustrated in FIG. 1 in sequential order, it is also contemplated that the steps may occur in different orders than illustrated and/or in parallel. Embodiments of the disclosed subject matter are thus not limited to the specific number of steps and order illustrated in FIG. 1.

In the first step 2 shown in FIG. 1, data of correct operational parameters is collected from at least one input device. For example, data may be provided from industrial control system 104 to the anomaly detection system 100 via an input/output (I/O) interface 112. The input device may include at least one of, for example, a sensor 108, from the SCADA 106 directly, from a distributed control system (DCS) 110, from remote I/O, a network, a virtual network, data logs and known libraries from databases. In some embodiments, the data collected may include for example at least one of: data from sensors operating within the control system 104, tags (i.e., from SCADA 106, PLC 136, or DCS 110), SCADA processing data, IT data, operator data, log files (i.e., from operating systems, IT, and/or SCADA 106), network data or communication data.

In some embodiments, the first step is optional and the step of collecting the data of the correct operational parameters may not be required for anomaly detection.

As the amount of data that may collected may be enormous, e.g., at least terabytes in size, some embodiments may include a second step 4 which may include big data collecting and/or big data handling. The big data handling may be done online, offline or via sub-sampling, for example, by transmitting the data to a remote data processing system 118.

In the third step 6, the data of the correct operational parameters may be analyzed and stored as training data. The step of analyzing may be broken down into two discreet steps. The data may first be processed and then analyzed. The step of processing may include: data correlation (e.g., correlating at least two operational parameters), rate of change differences, creating histograms, spectral analysis, recording delay patterns and interpreting the smoothness of the data. The analysis of the data include: developing a learning algorithm, developing temporal causalities, model analysis, Markovian connectivity analysis, Markov random field analysis and differential Markov random field analysis.

Referring again to FIG. 2, the anomaly detection system 100 can include data processing module 102, which can include a training module 114, an analysis module 116, and a data storage module 124. The training module 114 can perform the data processing and analysis of step 4. The data and/or the analysis may be stored in data storage module 124. In the fourth step 8, the data analysis module 116 of the anomaly detection system 100 can be trained using the training data and/or analysis from the training module 114. The anomaly detection system may therefore be trained in an initial training phase based on a secure system that has not yet been tainted by attacks. In some embodiments, the training may include training the system to produce a low false-positive ratio. The training may also include classifying the data deviation such that the system may interpret which deviations from the correct data are acceptable and which are not acceptable.

In the fifth step 10, current operational parameters may be detected in the industrial control system. For example, the analysis module 116 can receive data from the industrial control system 104 via I/O 112 and analyze the data as it is received in order to determine if an anomaly is present in the system. In particular, the anomaly detection system 100 may check the current operational parameter(s) (which may be the same parameters used to form the training data or different from the training data parameters but related in some way to the training data parameters), or the correlation of at least two current operational parameters, for any potential deviation from the training data that would indicate an abnormal or incorrect operation of the industrial control system 104. Such a deviation may be detected, if a portion of the industrial control system has been taken over by an attacker or otherwise manipulated.

For example, an operational parameter may fluctuate within a given range during normal operation, which range may be defined by analysis of historical data during said training. Values outside of the range in the training data would suggest an anomaly. In another example, comparison of two operational parameters, such as the ratio of the two parameters, which ratio may fluctuate within a given range during normal operation, may be used to determine if an anomaly is present.

In some embodiments, the method may include a feedback system, such that the data of the current operational parameters may be sent to the training of step 8 so that the current data can be added to the library of the training data. An offline feedback system may be included between step 8 and step 6. This feedback system may be used in order to take the “trained” data and use it as part of the overall data analysis.

In the sixth step 12, a communication function may be performed when the detected deviation is above or below a predefined threshold. For example, the communication function may include at least one of: creating an alarm (e.g., a visual or auditory alarm via alarm module 122), communicating data to at least one of a control system (e.g., to the SCADA 106 or the DCS 110) and an operator (e.g., to a system user via user interface 120 or to a user of the industrial control system via HMI 132), and recording the data (e.g., in data storage module 124) or the alarm.

Embodiments may relate to control networks in an industrial setting (including energy and water distribution or pipelines) or any other sector such as, but not limited to, telecommunication networks.

Some embodiments may include further systems, such as existing off-the-shelf open operating systems and software stacks, for example:
(i) Media access control (MAC) based security;
(ii) Defense against malware and security among contexts through isolation and use of restricted inter-context communications (ICC) application program interface (API);
(iii) Fast inter-process communication (IPC) mechanisms for high performance;
(iv) Resistance to denial of service (DoS) attacks through monitoring, prioritization, and load balancing among contexts.

Each communicating system entity (i.e., applications, processes, or remote systems) may be identified by an entity identifier that is unique within the secure industrial control system to which the system entity is connected. For example, applications, processes and tasks must each have unique IDs, but high-side subsystems may also each have unique IDs within the system if they communicate to other subsystems on the system, or within the entire system if they communicate outside the system. Identities may be formed from combinations of other identities in a hierarchical fashion as long as uniqueness is not compromised.

In one or more embodiments, anomaly detection system can additionally or alternatively be able to detect when operational parameters otherwise appear normal, for example, when an intruder sends data to an industrial control system to mask the fact that the industrial process has been comprised.

As illustrated in FIG. 4, an industrial control system, which is generally indicated at 410, is provided to facilitate overseeing and directing operation of an industrial process plant (or part thereof), which is generally indicated at 412. The industrial process plant 412 is designed to carry out an industrial process, such as power production, manufacturing, water treatment, desalinization, oil/gas refining, chemical, food/beverage production, etc. It thus comprises a plurality of control elements 14, each of which is utilized to carry out part of the process, and sensors 16, which are provided to measure operational parameters of the industrial process plant 412, and transmit information regarding the measurements to the industrial control system 410.

Non-limiting example of control elements 14 include valves, fans, conveyor belts, breakers, pumps, etc. Non-limiting examples of operational parameters which the sensors 16 are configured to measure include temperature, pressure, speed (for example of a conveyor belt) and/or state (e.g., on/off, revolutions per minute (RPM), etc.) of a control element 14, humidity, etc.; thus, the sensors 16 may include thermocouples, pitot tubes, humidistats, etc.

The industrial control system 410 is configured to receive information regarding operational parameters of the industrial process plant 412, and to present the information to an operator, for example graphically. This information may indicate to the operator that the industrial process plant 412 is undergoing a deviation from normal and/or safe operation, and that corrective action should be taken. In addition, the industrial control system 410 may be configured to determine, based on some or all of the information, that such a deviation is taking place, and alert an operator accordingly.

In addition, the industrial control system 410 may be configured to allow an operator to direct operation of some or all of the control elements 14 thereof, and/or it may do so autonomously. Thus, when measurements, provided by sensors 16, of one or more operational parameters indicate that a deviation in the system is taking place, appropriate corrective action can be taken, i.e., by controlling the appropriate control elements 14. The effects of operation can be verified by monitoring the appropriate operational parameters. This may be performed by an operator or autonomously.

For example, if information regarding a storage tank indicates that the internal pressure is dangerously high, the industrial control system may operate a control element 14, for example a relief valve, to correct this condition. The effect of this operation may be verified, for example, by monitoring the internal pressure to make sure that it is reduced to a safe level.

Use of the industrial control system 410 as described above to detect and correct deviations from normal and/or safe operation of the industrial process plant 412 is based on the premise that the industrial control system accurately reflects the operational parameters of the industrial process plant, and that directives issued thereby are received and carried out by the control elements 14 thereof. However, anomalies may occur when these premises are not true. For example, the industrial control system may be accessed by an unauthorized third party (hereafter, “intruder”), who takes control of the system. When taking control, the intruder presents information to the operator that the industrial process plant 412 is operating normally, while operating its control elements 14 in a dangerous way, which may lead to a catastrophic failure thereof.

In order to detect such anomalies, a response detector 18 may be provided. The response detector 18 may be a separate system which interfaces with the industrial control system 410, or it may be incorporated therein.

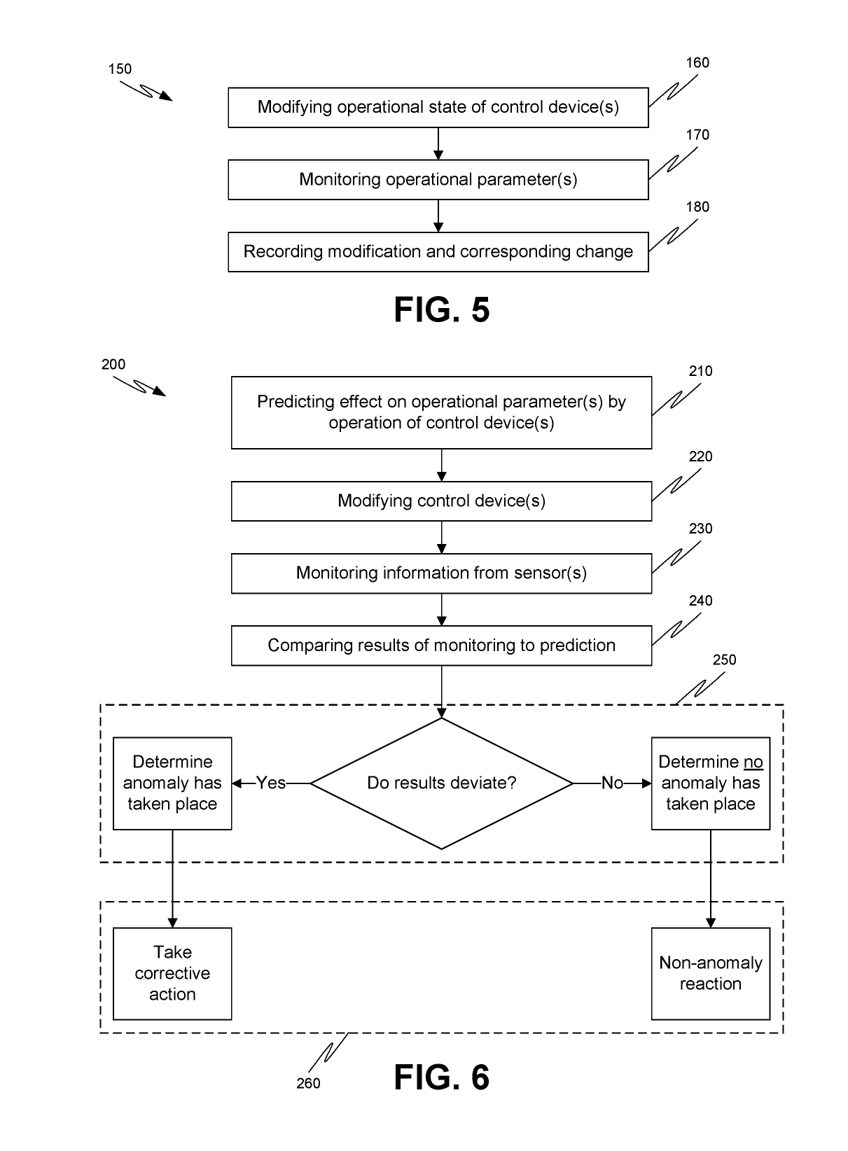

The response detector 18 is configured to issue commands, via the industrial control system 410, to control elements 14 of the industrial process plant 412. It is further configured to monitor operational parameters, as provided by the sensors 16. Moreover, it comprises a prediction engine 20 configured to predict the expected change to the operational parameters in response to the commands issued; accordingly, the industrial control system 410 is configured to alert an operator if the predicted response is not realized. In particular, the response detector 18 may be utilized in a method, such as will be described below with respect to FIG. 5, for detecting anomalies in the industrial control system 410.

The prediction engine 20 may be configured to arrive at its prediction in any suitable manner without deviating from the spirit and scope of the presently disclosed subject matter.

According to one embodiment, the prediction engine is configured to use a mathematical model of the industrial process plant 412 to predict the effect on one or more operational parameters in response to operation of one or more control elements 14. For example, the prediction engine may determine that opening a relief valve of a storage tank for a brief interval, e.g., several seconds, will lower the internal pressure of the storage tank by a given amount, or by a given range.

According to another embodiment, the prediction engine 20 is configured to undergo a learning procedure to gather prediction data. As illustrated in FIG. 5, the learning procedure 150 comprises steps of modifying 160, monitoring 170, and recording 180.

In the modifying step 160, the prediction engine modifies, in a predetermined way, an operational state of at least one of the control devices at a time when the anomaly is assumed not to be occurring.

In the monitoring step 170, the prediction engine monitors one or more operational parameters, as returned by the sensors 16, which are affected by the modification performed in step 160. This monitoring 170 can take place during and/or after the modifying 160.

In the recording step 180, the prediction engine records both the modification and information regarding the corresponding change in the operational parameters. The information includes the measured change in the operational parameter, and may also include information relating to the timing and duration of the change. The recorded information may be stored in a database, which is accessed by the prediction engine when compiling its prediction.

The prediction engine may carry out the learning procedure 150 for different control elements 14. In addition, it may carry out the learning procedure multiple times, thereby arriving at a range of predicted values.

As illustrated in FIG. 6, a method 200 is provided for detecting an anomaly which is consistent with an attacker having gained access to and controlling the supervisory control system. The method comprises the steps of predicting, modifying, monitoring, comparing, determining, and responding.

In the predicting step 210, the response detector 18 predicts, via the prediction engine 20, the effect on one or more operational parameters by a predetermined modification of an operational state of one or more one control devices. The modification may be small, such that its effect on an operational parameter does not negatively impact the operation of the industrial control plant 412, but large enough so that its effect on one or more operational parameters is both measurable and distinguished from fluctuations during normal operation. The predicted effect may be a discreet value, or a range of values.

In the modifying step 220, the response detector 18 performs the modification.

In the monitoring step 230, the response detector 18 monitors information provided by the sensors 16. The monitoring may be performed during and/or after the modification.

In the comparing step 240, the response detector 18 compares the result of the monitoring step 230 to the prediction obtained in the prediction step 210.

In the determining step 250, the response detector 18 determines, using the results of the comparing step, whether or not an anomaly has occurred. If the results of the monitoring step deviate from the prediction by more than a predetermined threshold, the response detector determines that an anomaly has occurred. If they do not deviate more than a predetermined threshold, the response detector determines that that an anomaly has not occurred.

In the responding step 260, the industrial control system 410 takes action in response to the result of the determining step 250. If the result indicates that an anomaly has occurred, the industrial control system 410 takes appropriate corrective action. Such an action may include alerting an operator, for example by displaying an alert and/or producing an audible alert, directing one or more of the control elements 14 to operate in such a way so as to mitigate the effects of the anomaly, or shutting down part or all of the industrial process plant. In addition, the corrective action may include two or more of the above or other actions.

If the results indicate that no anomaly has taken place, the industrial control system may take a non-anomaly reaction. These reactions may include recording relevant system data, analyzing system data, etc.

It will be appreciated that the steps do not have to be performed in the order presented. For example, the modifying and monitoring steps 220, 230 may be performed before the prediction step 210.

The response detector 18 may carry out the method 200 at regular or random intervals. In addition, it may vary the modifying step 220 (and thus the prediction step 210) during different iterations of the method 200. In this way, an intruder cannot easily mimic the operation of the response detector 18.

According to one aspect of the presently disclosed subject matter, there is provided a method of detecting a predetermined anomaly in an industrial control system, the industrial control system being configured to direct operation of control devices of at least one industrial process plant, and to receive measurements of operational parameters from the industrial process plant, the method comprising the steps of:
predicting the effect on or more of the operational parameters of performing a predetermined modification of an operational state of at least one of the control devices;
performing the modification;
monitoring the one or more operational parameters;
comparing results of the monitoring to the prediction; and
determining, if the results of the monitoring deviate from the prediction by more than a predetermined threshold, that an anomaly has occurred.

The method may further comprise, if it has been determined that an anomaly has occurred, taking a corrective action. The corrective action may be selected from a group consisting of displaying an alert, producing an audible alert, directing operation of one or more of said control devices, and shutting down at least part of said industrial process plant, or any combination thereof.

The method may further comprise responding to a detected deviation from the prediction. A suitable response may be selected according to the degree of deviation for example, performing anomaly detection reactions where an anomaly is identified and performing non-anomaly reactions where no anomaly is identified. Anomaly detection reactions may include at least one of: taking corrective actions, alerting, alarming or performing system overrides, combinations thereof and the like. Non-anomaly reactions may include at least one of:

recording deviation data, perhaps relating to degree of deviation, analyzing deviation data, combinations thereof and the like.

The monitoring may occur or begin before, during, and/or after the modification.

The method may further comprise performing the steps at regular or random intervals.

The predicting may be performed based on calculation of the effect the modification will have on the industrial process plant.

The predicting may be performed based on data collected during a learning procedure. The learning procedure may comprise the steps of:
modifying, in a predetermined way, an operational state of at least one of the control devices at a time when the anomaly is assumed not to be occurring;
monitoring one or more operational parameters for changes during and/or after the modifying; and
recording the modification and information regarding the corresponding change in the one or more operational parameters.

The learning procedure may comprise carrying out the steps more than once, e.g., a plurality of times.

The predetermined anomaly may be unauthorized access of the industrial control system by a third party. The third party may operate control devices of the industrial process plant under abnormal conditions, and send information to the industrial control system simulating measurements of operational parameters operating under normal condition.

The system may be a physical system. For example, it may be a power plant, such as a solar thermal power plant. The control devices may be configured to regulate at least one or more conditions selected from the group including temperature of a thermal fluid of the plant, pressure of the thermal fluid, angle of reflectors of the plant, temperature of working fluid of a turbine of the plant, and pressure of working fluid of a turbine of the plant.

The industrial process plant may be selected from a group including a nuclear power plant, a fossil fuel power plant, a hydroelectric power plant, a manufacturing plant, a water treatment plant, a desalination plant, an oil refinery, a chemical plant, and a food/beverage production plant.

According to another aspect of the presently disclosed subject matter, there is provided a non-transitory computer-readable data medium encoded with a computer program that comprises computer code for applying the above method.

It is noted that in order to implement the methods or systems of the disclosure, various tasks may be performed or completed manually, automatically, or combinations thereof. Moreover, according to selected instrumentation and equipment of particular embodiments of the methods or systems of the disclosure, some tasks may be implemented by hardware, software, firmware or combinations thereof using an operating system. For example, hardware may be implemented as a chip or a circuit such as an application specific integrated circuit (ASIC), integrated circuit or the like. As software, selected tasks according to embodiments of the disclosure may be implemented as a plurality of software instructions being executed by a computing device using any suitable operating system.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data. Optionally, a network connection may additionally or alternatively be provided. User interface devices may be provided such as visual displays, audio output devices, tactile outputs and the like. Furthermore, as required user input devices may be provided such as keyboards, cameras, microphones, accelerometers, motion detectors or pointing devices such as mice, roller balls, touch pads, touch sensitive screens or the like.

Embodiments of the disclosed subject matter are not limited to industrial process systems. Rather, one of ordinary skill in the art would readily appreciate that the method of anomaly detection can be applied to other systems as well. For example, the methods described herein are applicable to computer network systems, etc.

In any of the embodiments, the anomaly detection module, a classifier, may include a processor programmed to build a joint probability prediction model based on a history of normal operation. The training may be implemented using various supervised or unsupervised learning methods. In addition, the joint probability model can be any of a variety of non-linear network models and can include portions that include explicit manually entered joint probabilities as well as portions that are learned using many examples. The term joint probability may be used interchangeably with correlation.

In any of the embodiments, the anomaly detection module may be configured to detect system configuration outliers coinciding with normal testing and rejection, the integration in the model undergoing training. That is, anomaly detection module may be configured explicitly to detect permissible outliers and reject training data from such conditions from being incorporated in the model. Alternatively, the system may be manually placed in a mode where the anomaly detections are automatically rejected when a special operating or non-operating mode is implemented. In a particular preferred embodiment, unusual conditions such as maintenance, repair, testing, etc. can also be used as operating conditions and anomalies detected during such operating conditions as during normal operating conditions. Such unusual conditions can be a source of risk, especially if there is a physical interference by an unauthorized person. One way to detect physical interference with proper operation, including unusual conditions such as maintenance and trouble shooting, is to detect sensor and/or command data joint instances that correspond to known disallowed states. In the alternative approach, the system is trained to recognize the unusual sensor and command data attending special circumstances. One of the inputs of such circumstances may be data applied to the anomaly detection module that indicates a particular unusual operating mode such as maintenance. But the anomaly detection module still remains in a mode where it will detect and respond to anomalous conditions. This mode of operation has benefits because an intruder could issue a command to place the anomaly detection module into a special state in order to create misconfiguration mechanically or by generating command data.

The industrial system may have production and non-production operating modes. The non-production operating modes may be manually implemented by service or testing technicians or troubleshooting engineers, for example. The distinctive characteristics of such non-production modes include that they are infrequent and produce unusual operating states. To prevent the anomaly detection module from indicating anomalies under non-production modes, the anomaly detection module may be configured to allow an operator to place it in a state in which it either halts detection of anomalies or receives mode data indicating the instantiation of one or more specific non-production operating modes. Based on the mode data, for example generated through a user interface by an operator or technician, the anomaly detection module may permit all unusual conditions detected to go without taking certain actions (e.g., generating control outputs) that it would normally do during a production mode. Alternatively the anomaly detection module may include the mode data as an attribute in the operating attribute space that includes the sensor and industrial control output command data. The network model may have a set of allowed non-production operating ranges for such non-production modes that will permit the industrial system to be placed in configurations that correspond to such sensor and control output data without the anomaly detection module generating an anomaly condition. The sensor and control output data received during such non-production modes may be captured and used to train the anomaly detection module in the same way as during production modes. However, the non-production mode attribute space (combinations of sensor and control command data) in combination with the mode data would correspond to a different set of allowed attribute combinations thereby avoiding the output of anomaly detection by the anomaly detection module. The non-production modes may include maintenance, repair, and testing.

Non-production operating modes (i.e., non-anomalous or special) may include those attending maintenance operations, shutdown conditions, start-up conditions, and testing conditions. The learning mode for training the anomaly detection module may include applying sensor and command data signals to the anomaly detection module for training during such special conditions. The result of such training would be that the anomaly detection module would automatically detect these special conditions and evaluate and classify the states that are anomalous within the bounds of the special conditions, just like ordinary operating conditions. An additional input to the anomaly detection module may be data indicating the instantiation of an allowed special condition. This may be just one input to the anomaly detection module and combined with other data to indicate an anomaly.

In parallel with, or as a part of the development of the anomaly detection module, a visual display or other articulating output identifying the detected anomalous conditions can be generated. In the described embodiments wherein the normal conditions are learned by the anomaly detection module but the abnormal conditions are not necessarily explicitly predetermined or trained-on, the only output of the anomaly detection module may be an indication that the configuration of the system (configuration including sensor and control commands) does not fall within the envelope of joint probabilities that were learned to correspond to permissible conditions. However, a trained self-organizing map (SOM) may be able visually represent the envelope of normal conditions and further classify these as known general operating states. Then the anomalous conditions (outliers) may be displayed on the trained SOM to provide clues for determining the details of the anomaly. In a critical situation this could save time in an effort to protect against or recover quickly from an anomalous state. A color or topographical map may be generated on a user interface display for this purpose.

According to embodiments, a control system protection mechanism is provided that detects unauthorized interference with an industrial control system controlling an industrial system. The protection mechanism is embodied in a programmable anomaly detection module connected to sensors to receive sensor data, the sensor data representing a configuration of the industrial system. The programmable anomaly detection module is also connected to control outputs of the industrial control system to receive control output data, the control output data commanding functions of the industrial system. The anomaly detection module has a processor and a data store with executable instructions to cause the processor to generate error commands responsively to a network model, on a data store of the anomaly detection module that distinguishes non-anomalous attribute combinations in an attribute space defined by all possible values of the control output data and sensor data. The error commands may include at least one command applied to the industrial control system effective to cause the industrial control system to take a corrective or protective action when the network model indicates that a current combination of sensor data and control output data lies outside the non-anomalous combination. The industrial system may have one or more production operating modes and one or more non-production operating modes, the latter corresponding to testing. The non-production non-anomalous operating modes can be any of the ones identified. They may also be defined as the class of conditions in which the industrial system is not producing energy, information, products or other service values but which is not an unauthorized event such as an intrusion or takeover of the industrial system.

The network model may be generated by training the network model using labeled and/or unlabeled data obtained by operating the industrial system during production modes and receiving the attending sensor data and control output data of the industrial system during non-anomalous operation or by selecting the attending sensor data and control output data corresponding to non-anomalous operation. The industrial control system may be signally connected to the anomaly detection module to receive said at least one of said error commands. An alarm output device may be connected to the anomaly detection module to receive at least another of said error commands and to generate an alarm notification receivable by one or more operators responsively thereto. The alarm output device or the anomaly detection module may be configured to detect a loss of connection between said alarm output device and said anomaly detection module and to generate an alarm notification upon said loss of connection.

In any combination of the foregoing system embodiments, the corrective or protective action may include changing a configuration of the industrial system effective to protect the industrial system. In any combination of the foregoing system embodiments, the industrial control system is signally connected to the anomaly detection module by an optical or electrically-conductive communication cable to receive said at least one of said error commands. In any combination of the foregoing system embodiments, the network model may also be generated by training the network model using labeled and/or unlabeled data obtained by operating the industrial system during non-production modes and receiving the attending sensor data and control output data of the industrial system during non-anomalous or be selecting the attending sensor data and control output data corresponding to non-anomalous operation. In any combination of the foregoing system embodiments, the anomaly detection module may have a graphic output that graphically represents a combination of sensor and control output data corresponding to or indicated as anomalous by the anomaly detection module. In any combination of the disclosed (i.e., foregoing or following) system embodiments, the anomaly detection module may have a graphic output that graphically represents a combination of sensor and control output data corresponding to or indicated as anomalous by the anomaly detection module. In any combination of the foregoing system embodiments, the graphic output may be derived from a self-organizing map. In any combination of the disclosed embodiments, the network model may also generated by training the network model using labeled and/or unlabeled data obtained by operating the industrial system during non-production modes and receiving the attending sensor data and control output data of the industrial system during non-anomalous or be selecting the attending sensor data and control output data corresponding to non-anomalous operation and the anomaly detection module has a graphic output that graphically represents a combination of sensor and control output data corresponding to or indicated as anomalous by the anomaly detection module. In one or more first embodiments, a method of detecting anomalies in an industrial control system comprises analyzing data of correct operational parameters from at least one input device and storing the correct operational parameters or a correlation of at least two correct operational parameters as training data. The method further comprises training an anomaly detection system using the training data. The method also comprises detecting current operational parameters of the at least one input device. The method further comprises checking, by the anomaly detection system, at least one of an operational parameter or a correlation of at least two operational parameters to detect a deviation from the training data. The method also comprises performing a communication function when the detected deviation is above or below a defined threshold. The communication function is one of: creating an alarm, communicating data to at least one of a control system and an operator, and recording the data or the alarm.

In one or more second embodiments, a method of detecting anomalies in an industrial control system comprises analyzing historical data of correct operational parameters from at least one input device and storing the correct operational parameters or a correlation of at least two correct operational parameters as training data. The method further comprises training an anomaly detection system using the training data. The method also comprises detecting current operational parameters of the at least one input device. The method further comprises, by the anomaly detection system, analyzing the current operational parameters with respect to the training data so as to detect a deviation in the current operational parameters. The method also comprises performing a communication function when the detected deviation is above or below a predefined threshold. The communication function comprises at least one of: creating an alarm, communicating data associated with the detected deviation to at least one of the industrial control system and an operator, and recording the alarm or data associated with the detected deviation.

In one or more third embodiments, a method of detecting anomalies in an industrial control system comprises analyzing data of correct operational parameters from at least one input device and storing the correct operational parameters or a correlation of at least two operational parameters as training data. The method further comprises detecting current operational parameters of the at least one input device. The method also comprises checking at least one of an operational parameter or a correlation of at least two operational parameters to detect a deviation from the training data. The method further comprises performing a communication function when the detected deviation is above or below the defined threshold.

In one or more fourth embodiments, a method of detecting anomalies in an industrial control system comprises analyzing historical data of correct operational parameters from at least one input device and storing the correct operational parameters or a correlation of at least two operational parameters as training data. The method further comprises detecting current operational parameters of the at least one input device. The method also comprises analyzing the current operational parameters with respect to the training data to detect a deviation in the current operational parameters. The method further comprises performing a communication function when the detected deviation is above or below a predefined threshold.

In one or more fifth embodiments, a method of detecting anomalies in an industrial control system is performed by an anomaly detection module. The method comprises analyzing data representing current operational parameters of the industrial control system with respect to historical data representing normal operational parameters of the industrial control system. The method further comprises creating an alarm responsively to when the analyzing indicates that the operating parameters deviate from normal operation.

In one or more sixth embodiments, a method of detecting anomalies in an industrial control system is performed by an anomaly detection system. The method comprises generating a model of normal operation of the industrial control system. The model comprises values or a range of values for one or more operational parameters of the industrial control system. The model is generated based on historical data representing normal operational parameters of the industrial control system. The method further comprises analyzing data representing current operational parameters of the industrial control system with respect to said model. The method also comprises creating an alarm responsively to when the analyzing indicates a deviation from said model that exceeds a predetermined threshold.

In the fifth and sixth embodiments, or any other embodiment, the creating an alarm comprises at least one of generating a visual or auditory alarm, communicating said data to the industrial control system or an operator thereof, and recording the data and/or the deviation.

In any of the first through sixth embodiments, or any other embodiment, the method further comprises collecting data of the correct operational parameters from the at least one input device.

In any of the first through sixth embodiments, or any other embodiment, the at least one input device is at least one of the industrial control system, a supervisory control and data acquisition (SCADA) system, a sensor, remote input/output (I/O) hardware, a virtual network and data logs.

In any of the first through sixth embodiments, or any other embodiment, the industrial control system includes at least one sub-control system comprising at least one of a distributed control system, a heliostat control system and a user control system.

In any of the first through sixth embodiments, or any other embodiment, during the checking or the analyzing, the anomaly detection system or module detects a deviation when a component in a control network of the industrial control system has been taken over by an attacker or has been changed by a user without permission.

In any of the first through sixth embodiments, or any other embodiment, the anomaly detection system or module comprises a device-based intrusion detection system.

In any of the first through sixth embodiments, or any other embodiment, the performing the communication function is based on a number of identified anomalies within a particular time interval, the identified anomalies being detected deviations that exceed the threshold.

In any of the first through sixth embodiments, or any other embodiment, the method also includes learning normal behavior of the control network by observing and/or simulating the correct operational parameters or the correlation between at least two correct operational parameters. The anomalies are identified as deviations from such learned normal behavior.

In any of the first through sixth embodiments, or any other embodiment, the data of correct operational parameters comprise data obtained during normal usage of input devices to the industrial control system, during storm effects, and during typical maintenance operations.

In any of the first through sixth embodiments, or any other embodiment, the deviation is due to at least one of spoofing a master, spoofing a remote terminal unit, and denial of service.

In any of the first through sixth embodiments, or any other embodiment, the anomaly detection system comprises a network-based intrusion detection system wherein at least one of a time sequence and time intervals of correct messages are monitored.

In any of the first through sixth embodiments, or any other embodiment, the method can be performed by a non-transitory computer-readable data medium encoded with a computer program that comprises computer code for applying said method.

In any of the first through sixth embodiments, or any other embodiment, the method can be performed by a system configured to perform said method.

In one or more seventh embodiments, a system for detecting anomalies in an industrial control system comprises a training module and a data analysis module. The training module is configured to analyze historical data of operational parameters of the industrial control system and to determine normal operating criteria for evaluating current operational parameters of the industrial control system based on the analysis of the historical data. The data analysis module is configured to analyze data indicative of current operational parameters of the industrial control system with respect to the normal operating criteria and to detect the presence of an anomaly based on a deviation determined responsively to the analysis of the current data.

In the seventh embodiments, or any other embodiment, the system further comprises a communication module. The communication module is configured to perform a communication function responsively to the detected anomaly by the data analysis module.

In the seventh embodiments, or any other embodiment, the communication function comprises at least one of generating a visual or auditory alarm, communicating data related to the deviation to the industrial control system or an operator thereof, and recording the data and/or the deviation.

In one or more eighth embodiments, a method of detecting an anomaly in an industrial control system is provided. The industrial control system is configured to direct operation of control devices of at least one industrial process plant and to receive measurements of operational parameters from said industrial process plant. The method includes predicting the effect on one or more of the operational parameters of performing a predetermined modification of an operational state of at least one of the control devices. The method further includes performing the modification and monitoring the one or more operational parameters. The method also includes comparing results of the monitoring to at least one predicted effect, and determining, if the results of the monitoring deviate from the at least one predicted effect by more than a predetermined threshold, that the anomaly has occurred.

In the eighth embodiments, or any other embodiment, the method further comprises if it has been determined that an anomaly has occurred, taking a corrective action.

In the eighth embodiments, or any other embodiment, the corrective action is selected from a group consisting of displaying an alert, producing an audible alert, directing operation of one or more of said control devices, shutting down at least part of said industrial process plant, and a combination thereof.

In the eighth embodiments, or any other embodiment, the monitoring begins during the modification.

In the eighth embodiments, or any other embodiment, the monitoring begins after the modification.

In the eighth embodiments, or any other embodiment, the monitoring begins before the modification.

In the eighth embodiments, or any other embodiment, the method further comprises performing the steps at random intervals.

In the eighth embodiments, or any other embodiment, the predicting is performed based on calculation of the effect the modification will have on the industrial process plant.

In the eighth embodiments, or any other embodiment, the predicting is performed based on data collected during a learning procedure.

In the eighth embodiments, or any other embodiment, the learning procedure includes modifying, in a predetermined way, an operational state of at least one of said control devices at a time when said anomaly is assumed not to be occurring. The learning procedure further includes monitoring one or more operational parameters for changes during and/or after the modifying. The learning procedure also includes recording the modification and information regarding the corresponding change in said one or more operational parameters.

In the eighth embodiments, or any other embodiment, the learning procedure comprises carrying out the steps a plurality of times.

In the eighth embodiments, or any other embodiment, the predetermined anomaly is unauthorized access of the industrial control system by a third party.

In the eighth embodiments, or any other embodiment, the third party operates control devices of the industrial process plant under abnormal conditions, and sends information to the industrial control system simulating measurements of operational parameters operating under normal condition.

In the eighth embodiments, or any other embodiment, the system is a physical system.

In the eighth embodiments, or any other embodiment, the system is a power plant.

In the eighth embodiments, or any other embodiment, the industrial process plant is a solar thermal power plant.

In the eighth embodiments, or any other embodiment, the control devices are configured to regulate at least one or more conditions selected from the group including temperature of a thermal fluid of the plant, pressure of the thermal fluid, angle of reflectors of the plant, temperature of working fluid of a turbine of the plant, and pressure of working fluid of a turbine of the plant.

In the eighth embodiments, or any other embodiment, the industrial process plant is selected from a group including a nuclear power plant, a fossil fuel power plant, a hydroelectric power plant, a manufacturing plant, a water treatment plant, a desalination plant, an oil refinery, a chemical plant, and a food/beverage production plant.

In one or more ninth embodiments, a method of detecting an anomaly in an industrial process plant includes predicting a value of an operational parameter of the industrial process plant after a control device therein has been subject to a known operating state modification. The method also includes instructing the control device to have the known operating state modification and comparing a value of the operational parameter resulting from the instructing with the predicted value. The method further includes controlling the industrial control system responsively to a result of the comparing.

In the ninth embodiments, or any other embodiment, the controlling comprises indicating an anomaly when a difference between the compared values is greater than a predefined threshold.

In the ninth embodiments, or any other embodiment, the controlling comprises taking corrective action in response to the indicated anomaly.

In one or more tenth embodiments, a method of detecting an anomaly in an industrial process plant includes predicting a response of the industrial process plant to a perturbation produced by a control device therein. The response is indicated by a change in an operational parameter of the industrial process plant. The method further includes comparing an actual response of the industrial process plant to the perturbation with the predicted result, and determining existence of an anomaly responsively to the comparing.

In the tenth embodiments, or any other embodiment, the method further includes taking corrective action responsively to the determination of the anomaly.

In the tenth embodiments, or any other embodiment, the corrective action comprises at least one of generating a visual or audible alert, directing operation of the control device or another control device within the industrial process plant, and shutting down or disabling part of the industrial process plant.

In one or more eleventh embodiments, a control system protection mechanism detects unauthorized interference with an industrial control system controlling an industrial system. The control system protection mechanism comprises a programmable anomaly detection module. The programmable anomaly detection module is connected to sensors to receive sensor data. The sensor data represents a configuration of the industrial system. The programmable anomaly detection module is also connected to control outputs of the industrial control system and to receive control output data. The control output data commands functions of the industrial system. The anomaly detection module comprises a processor and a data store with executable instructions to cause the processor to generate error commands responsively to a network model. The network model is on the data store of the anomaly detection module and distinguishes non-anomalous attribute combination in an attribute space defined by all possible values of the control output data and sensor data. The error commands includes at least one command applied to the industrial control system effective to cause the industrial control system to take a corrective or protective action when the network model indicates that a current combination of sensor data and control output data lies outside the non-anomalous combination. The industrial system has one or more production operating modes and one or more non-production operating modes. The non-production operating modes correspond to testing, maintenance, startup, or shutdown. The non-anomalous combinations include conditions during the non-production operating modes. The network model is generated by training the network model using unlabeled data obtained by operating the industrial system during production modes and receiving the attending sensor data and by controlling output data of the industrial system during non-anomalous operation or by selecting the attending sensor data and control output data corresponding to non-anomalous operation. The industrial control system is signally connected to the anomaly detection module to receive said at least one of the error commands. An alarm output device can be connected to the anomaly detection module to receive at least another of the error commands and to generate an alarm notification receivable by one or more operators responsively thereto. The alarm output device or the anomaly detection module is configured to detect a loss of connection between the alarm output device and the anomaly detection module and to generate an alarm notification upon said loss of connection.

In the eleventh embodiments, or any other embodiment, the corrective or protective action includes changing a configuration of the industrial system effective to protect the industrial system.

In the eleventh embodiments, or any other embodiment, the industrial control system is signally connected to the anomaly detection module by an optical or electrically-conductive communication cable to receive said at least one of said error commands.

In the eleventh embodiments, or any other embodiment, the network model is also generated by training the network model using unlabeled data obtained by operating the industrial system during non-production modes and receiving the attending sensor data and control output data of the industrial system during non-anomalous operation or by selecting the attending sensor data and control output data corresponding to non-anomalous operation.

In the eleventh embodiments, or any other embodiment, the anomaly detection module has a graphic output that graphically represents a combination of sensor and control output data corresponding to or indicated as anomalous by the anomaly detection module.

In the eleventh embodiments, or any other embodiment, the anomaly detection module has a graphic output that graphically represents a combination of sensor and control output data corresponding indicated as anomalous by the anomaly detection module.

In the eleventh embodiments, or any other embodiment, the graphic output is derived from a self-organizing map.

In one or more twelfth embodiments, a control system protection mechanism detects unauthorized interference with an industrial control system controlling an industrial system. The control system protection mechanism comprises at least a programmable anomaly detection module connected to sensors to receive sensor data. The sensor data represents a configuration of the industrial system. The programmable anomaly detection module is also connected to control outputs of the industrial control system to receive control output data. The control output data commands functions of the industrial system. The anomaly detection module comprises a processor and a data store with executable instructions to cause the processor to generate error commands responsively to a network model that is on a data store of the anomaly detection module and distinguishes non-anomalous attribute combination in an attribute space defined by all possible values of the control output data and sensor data. The error commands include at least one command applied to the industrial control system effective to cause the industrial control system to take a corrective or protective action when the network model indicates that a current combination of sensor data and control output data lies outside the non-anomalous combination. The industrial system has one or more production operating modes and one or more non-production operating modes. The network model is generated by training the network model using labeled and unlabeled data obtained by operating the industrial system during production modes and receiving the attending sensor data and control output data of the industrial system during non-anomalous operation or by selecting the attending sensor data and control output data corresponding to non-anomalous operation. The industrial control system is signally connected to the anomaly detection module to receive the at least one of the error commands. An alarm output device is connected to the anomaly detection module to receive at least another of said error commands and to generate an alarm notification receivable by one or more operators responsively thereto. The alarm output device or the anomaly detection module is configured to detect a loss of connection between the alarm output device and the anomaly detection module and to generate an alarm notification upon the loss of connection.

In the twelfth embodiments, or any other embodiment, the corrective or protective action includes changing a configuration of the industrial system effective to protect the industrial system.

In the twelfth embodiments, or any other embodiment, the industrial control system is signally connected to the anomaly detection module by an optical or electrically-conductive communication cable to receive said at least one of said error commands.

In the twelfth embodiments, or any other embodiment, the network model is also generated by training the network model using labeled and/or unlabeled data obtained by operating the industrial system during non-production modes and receiving the attending sensor data and control output data of the industrial system during non-anomalous operation or by selecting the attending sensor data and control output data corresponding to non-anomalous operation.

In the twelfth embodiments, or any other embodiment, the anomaly detection module has a graphic output that graphically represents a combination of sensor and control output data corresponding to or indicated as anomalous by the anomaly detection module.

In the twelfth embodiments, or any other embodiment, the anomaly detection module has a graphic output that graphically represents a combination of sensor and control output data corresponding indicated as anomalous by the anomaly detection module.

In the twelfth embodiments, or any other embodiment, the graphic output is derived from a self-organizing map.

In the twelfth embodiments, or any other embodiment, the network model is also generated by training the network model using labeled and/or unlabeled data obtained by operating the industrial system during non-production modes and receiving the attending sensor data and control output data of the industrial system during non-anomalous operation or by selecting the attending sensor data and control output data corresponding to non-anomalous operation.

In the twelfth embodiments, or any other embodiment, the anomaly detection module has a graphic output that graphically represents a combination of sensor and control output data corresponding indicated as anomalous by the anomaly detection module.

In one or more thirteenth embodiments, aspects of one or more of the above noted first through twelfth embodiments are combined together. For example, an anomaly detection method according to the first embodiments can be combined with the anomaly detection method according to the eighth embodiments. In another example, the control system protection mechanism of the eleventh or twelfth embodiments can be configured to perform the anomaly detection method according to the first and eight embodiments.

In any embodiment, a non-transitory computer-readable data medium encoded with a computer program that comprises computer code can be used to apply the disclosed method.

In any embodiment, a system can be configured to perform the disclosed method.

In one or more embodiments of the disclosed subject matter, non-transitory computer-readable storage media and a computer processing systems can be provided. In one or more embodiments of the disclosed subject matter, non-transitory computer-readable storage media can be embodied with a sequence of programmed instructions for detecting anomalies in an industrial control system, the sequence of programmed instructions embodied on the computer-readable storage medium causing the computer processing systems to perform one or more of the disclosed methods.

It will be appreciated that the modules, processes, systems, and devices described above can be implemented in hardware, hardware programmed by software, software instruction stored on a non-transitory computer readable medium or a combination of the above. For example, a method for detecting anomalies in an industrial control system can be implemented, for example, using a processor configured to execute a sequence of programmed instructions stored on a non-transitory computer readable medium. For example, the processor can include, but is not limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, Lab VIEW, or another structured or object-oriented programming language. The sequence of programmed instructions and data associated therewith can be stored in a non-transitory computer-readable medium such as a computer memory or storage device which may be any suitable memory apparatus, such as, but not limited to read-only memory (ROM), programmable read-only memory (PROM), electrically erasable programmable read-only memory (EEPROM), random-access memory (RAM), flash memory, disk drive and the like.

Furthermore, the modules, processes, systems, and devices can be implemented as a single processor or as a distributed processor. Further, it should be appreciated that the steps mentioned herein may be performed on a single or distributed processor (single and/or multi-core). Also, the processes, modules, and sub-modules described in the various figures of and for embodiments herein may be distributed across multiple computers or systems or may be co-located in a single processor or system. Exemplary structural embodiment alternatives suitable for implementing the modules, sections, systems, means, or processes described herein are provided below.

The modules, processes, systems, and devices described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the methods, processes, modules, devices, and systems (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the methods, systems, or computer program products (software program stored on a non-transitory computer readable medium).

Furthermore, embodiments of the disclosed methods, processes, modules, devices, systems, and computer program product may be readily implemented, fully or partially, in software using, for example, object or object-oriented software development environments that provide portable source code that can be used on a variety of computer platforms. Alternatively, embodiments of the disclosed methods, processes, modules, devices, systems, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized. Embodiments of the methods, processes, modules, devices, systems, and computer program product can be implemented in hardware and/or software using any known or later developed systems or structures, devices and/or software by those of ordinary skill in the applicable art from the function description provided herein and with a general basic knowledge of anomaly detection, industrial control systems, and/or computer programming arts.

In this application, unless specifically stated otherwise, the use of the singular includes the plural and the use of “or” means “and/or.” Furthermore, use of the terms “including” or “having,” as well as other forms, such as “includes,” “included,” “has,” or “had” is not limiting. Any range described herein will be understood to include the endpoints and all values between the endpoints.

Features of the disclosed embodiments may be combined, rearranged, omitted, etc., within the scope of the invention to produce additional embodiments. Furthermore, certain features may sometimes be used to advantage without a corresponding use of other features.

It is thus apparent that there is provided in accordance with the present disclosure, system, methods, and devices for detecting anomalies in an industrial control system. Many alternatives, modifications, and variations are enabled by the present disclosure. While specific embodiments have been shown and described in detail to illustrate the application of the principles of the present invention, it will be understood that the invention may be embodied otherwise without departing from such principles. Accordingly, Applicants intend to embrace all such alternatives, modifications, equivalents, and variations that are within the spirit and scope of the present invention.

1. A control system protection mechanism that detects unauthorized interference with an industrial control system controlling an industrial system, comprising:
a programmable anomaly detection module connected to sensors to receive sensor data, the sensor data representing a configuration of the industrial system;
the programmable anomaly detection module also being connected to control outputs of the industrial control system and to receive control output data, the control output data commanding functions of the industrial system;
the anomaly detection module having a processor and a data store with executable instructions to cause the processor to generate error commands responsively to a network model, on a data store of the anomaly detection module, that distinguishes non-anomalous attribute combination in an attribute space defined by all possible values of the control output data and sensor data;
the error commands including at least one command applied to the industrial control system effective to cause the industrial control system to take a corrective or protective action when the network model indicates that a current combination of sensor data and control output data lies outside the non-anomalous combination;
wherein the industrial system has one or more production operating modes and one or more non-production operating modes, the latter corresponding to testing, maintenance, startup, or shutdown, non-anomalous combinations include conditions during non-production operating modes,
the network model being generated by training the network model using unlabeled data obtained by operating the industrial system during production modes and receiving the attending sensor data and control output data of the industrial system during non-anomalous operation or by selecting the attending sensor data and control output data corresponding to non-anomalous operation;
the industrial control system being signally connected to the anomaly detection module to receive said at least one of said error commands;
an alarm output device connected to the anomaly detection module to receive at least another of said error commands and to generate an alarm notification receivable by one or more operators responsively thereto;
said alarm output device or said anomaly detection module being configured to detect a loss of connection between said alarm output device and said anomaly detection module and to generate an alarm notification upon said loss of connection.

2. The system of claim 1, wherein the corrective or protective action includes changing a configuration of the industrial system effective to protect the industrial system.

3. The system of claim 1, wherein the industrial control system is signally connected to the anomaly detection module by an optical or electrically-conductive communication cable to receive said at least one of said error commands.

4. The system of claim 1, wherein the network model is also generated by training the network model using unlabeled data obtained by operating the industrial system during non-production modes and receiving the attending sensor data and control output data of the industrial system during non-anomalous operation or by selecting the attending sensor data and control output data corresponding to non-anomalous operation.

5. The system of claim 4, anomaly detection module has a graphic output that graphically represents a combination of sensor and control output data corresponding to or indicated as anomalous by the anomaly detection module.

6. The system of claim 1, anomaly detection module has a graphic output that graphically represents a combination of sensor and control output data corresponding to or indicated as anomalous by the anomaly detection module.

7. The system of claim 6, wherein the graphic output is derived from a self-organizing map.

8. (canceled)

9. (canceled)

10. (canceled)

11. (canceled)

12. (canceled)

13. (canceled)

14. (canceled)

15. (canceled)

16. (canceled)

17. (canceled)

18. A method of detecting anomalies in an industrial control system, comprising:
analyzing historical data of correct operational parameters from at least one input device and storing the correct operational parameters or a correlation of at least two correct operational parameters as training data;
training an anomaly detection system using the training data;
detecting current operational parameters of the at least one input device;
by the anomaly detection system, analyzing the current operational parameters with respect to the training data so as to detect a deviation in the current operational parameters; and
performing a communication function when the detected deviation is above or below a predefined threshold;
wherein the communication function comprises at least one of: creating an alarm, communicating data associated with the detected deviation to at least one of the industrial control system and an operator, and recording the alarm or data associated with the detected deviation.

19. (canceled)

20. (canceled)

21. (canceled)

22. (canceled)

23. (canceled)

24. The method of claim 18, further comprising collecting data of the correct operational parameters from the at least one input device.

25. The method of claim 18, wherein the at least one input device is at least one of the industrial control system, a supervisory control and data acquisition (SCADA) system, a sensor, remote input/output (I/O) hardware, a virtual network and data logs.

26. The method of claim 18, wherein the industrial control system includes at least one sub-control system comprising at least one of a distributed control system, a heliostat control system and a user control system.

27. The method of claim 18, wherein, during the checking or the analyzing, the anomaly detection system or module detects a deviation when a component in a control network of the industrial control system has been taken over by an attacker or has been changed by a user without permission.

28. The method of claim 18, wherein the anomaly detection system or module comprises a device-based intrusion detection system.

29. The method of claim 18, wherein the performing the communication function is based on a number of identified anomalies within a particular time interval, the identified anomalies being detected deviations that exceed the threshold.

30. The method of claim 18, further comprising learning normal behavior of the control network by observing and/or simulating the correct operational parameters or the correlation between at least two correct operational parameters, and wherein anomalies are identified as deviations from such learned normal behavior.

31. The method of claim 18, wherein the data of correct operational parameters comprise data obtained during normal usage of input devices to the industrial control system, during storm effects, and during typical maintenance operations.

32. The method of claim 18, wherein the deviation is due to at least one of spoofing a master, spoofing a remote terminal unit, and denial of service.

33. The method of claim 18, wherein the anomaly detection system comprises a network-based intrusion detection system wherein at least one of a time sequence and time intervals of correct messages are monitored.

34. (canceled)

35. (canceled)

36. (canceled)

37. (canceled)

38. (canceled)

39. The system of claim 1, wherein the anomaly detection module is further configured to predict a configuration response of the industrial system to a known control output, to control the industrial system to have the known control output and compare the resulting configuration with the predicted configuration, and to further control the industrial system responsively to the comparison.

40. The system of claim 1, wherein the data store of the anomaly detection module includes executable instructions to cause the processor to (a) predict an effect on one or more of the operational parameters of performing a predetermined modification of an operational state of at least one of the control devices, (b) perform the modification, (c) monitor the one or more operational parameters, (d) compare results of the monitoring to the prediction, and (e) determine, if the results of the monitoring deviate from the prediction by more than a predetermined threshold, that an anomaly has occurred.

41. The method of claim 18, further comprising:
predicting an effect on one or more of the operational parameters of performing a predetermined modification of an operational state of at least one of the control devices;
performing the modification;
monitoring the one or more operational parameters;
comparing results of the monitoring to the prediction; and
determining, if the results of the monitoring deviate from the prediction by more than a predetermined threshold, that an anomaly has occurred.
